(19) United States
(12) Patent Application Publication
(10) Pub. No.: US 2009/0248529 A1
(43) Pub. Date: Oct. 1, 2009

(54) SYSTEM AND METHOD FOR PROVIDING VALUE ADDED SERVICES VIA WIRELESS ACCESS POINTS

(75) Inventors: Karthikeyan Balaji Dhanapal, Bangalore (IN); Puneet Gupta, Bangalore (IN)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Infosys Technologies Limited, Bangalore (IN)

(21) Appl. No.: 12/416,378

(22) Filed: Apr. 1, 2009

(30) Foreign Application Priority Data
Apr. 1, 2008 (IN) 822/CHE/2008

(51) Int. Cl. G06Q 30/00; G06F 17/30; G06F 3/048; G06F 15/16

(52) U.S. Cl. 705/14.55; 707/4; 715/738; 709/203; 707/E17.109

(57) ABSTRACT

A method for providing value added services to a user terminal by an access point in a wireless network is provided. The method comprises intercepting a request initiated by a user terminal for accessing information. The method further comprises determining if the request is a local search request. If the request is a local search request, then location information is appended to the request. Location specific search results are rendered on the user terminal.

### FIELD OF THE INVENTION

The present invention relates to wireless networks and more specifically to provide value added services to wireless devices via access points in a wireless network.

### BACKGROUND OF THE INVENTION

Technological advancements have made wireless communications devices inexpensive and accordingly ubiquitous. With increase in mobile computing devices such as laptops, tablets, personal digital assistants, portable navigators etc., there has been a continuous demand to connect them wirelessly and efficiently.

Most of the mobile computing devices used nowadays have built-in wireless capability to connect to a wireless network. A wireless enabled device attempting to receive and transfer data in a wireless network needs to establish a connection with a local access point present in a wireless network. A preliminary step in establishing connection includes the wireless device entering the vicinity of an access point and the access point introducing itself by transmitting a service set identifier in a broadcast packet. The broadcast packet is then received by wireless enabled device present in the network. Wireless devices then complete the connection establishment process by exchanging information with the wireless access point, such as security information, bandwidth information, wireless network identifier, device identifier, etc.

Wireless access point generally acts as a transceiver for exchanging data packets between the wireless devices and the wireless network. The information present in the data packets destined to wireless device is simply received and transmitted by the access point and no significant processing takes place as far as data is concerned. Typically, access points are not aware of the information that is present in the data packets and thus are not able to utilize the information for providing any value added service.

An example of a value added service may be that the user of a mobile wireless device may require access to hotels and restaurants in vicinity while moving within a certain geographical area. In such a scenario, the user may search for various hotels and restaurants via internet service provided by the access point. The user may then have to navigate through all the search results and then may have to give new search strings to finalize a particular hotel or restaurant.

Similarly, in another example, a user of a mobile wireless device may wish to avail various rental services such as taxis, cafes, video libraries etc., while travelling in a new place or city. If these services are not available on the move the user may have to fetch various directories or browse numerous web pages that may or may not be relevant to that particular geographic area to extract information thus making the entire process arduous and inconvenient.

In light of the abovementioned disadvantages, there is a need for a system and method in a wireless network which can deliver relevant search results by combining search request with location information. Further, there is a need for an intelligent access point which can deliver information in a device friendly manner by combining location information and the information queried by the user.

### BRIEF SUMMARY OF THE INVENTION

A method for providing value added services to a user terminal by an access point in a wireless network is provided. The method comprises intercepting a request, the request being initiated by a user terminal for accessing information; determining if the request comprises a search request; determining if the search request corresponds to a local search request; adding location information to the search request if the request is the local search request; and rendering location specific search results on the user terminal. In an embodiment of the present invention, the request is determined as a search request based on at least one of: website to which the request is directed and content of the request.

In an embodiment of the present invention, the request is determined as a local search request based on information present in a Local Searchable Database (LSD). In another embodiment of the present invention, the location information comprises at least one of: user location, latitude and longitude information of the access point to which the user is connected.

In an embodiment of the present invention, the method further comprises combining search results received from an external search engine with location specific search results, and rendering combined search results on the user terminal.

In an embodiment of the present invention the method further comprises extracting Internet Protocol (IP) address and device specific information of the user terminal from the request; tagging the IP address with the corresponding device specific information; and storing the tagged information in a Request Data Cache (RDC).

In an embodiment of the present invention the method further comprises rendering search results from one or more websites on the user terminal based on capabilities of the user terminal. The user terminal capabilities being at least one of: screen size and browser support.

In an embodiment of the present invention the method further comprises modifying search results when one or more websites do not provide search results according to capabilities of the user terminal.

In an embodiment of the present invention the method further comprises delivering advertisements when the user terminal navigates between web pages associated with the search results.

A system for providing value added services to a user terminal in a wireless network is provided. The system comprises a user terminal configured to initiate a request for accessing information from one or more search engines. The system further comprises an access point. The access point comprises a Local Searchable Database (LSD) to store keywords relating to one or more local search requests and a Message Modifying module (MM) to intercept and add location information to the request, if the request is a local search request, thereby rendering location specific search results on the user terminal.

In an embodiment of the present invention, the system further comprises a Transport Protocol Field Modifying module (TPFM) to modify Transport Control Protocol (TCP) header of the request based on the location information.

In an embodiment of the present invention, the system further comprises an external search engine configured to receive requests from the user at TCP layer of Internet Protocol Suite of the wireless network.

In an embodiment of the present invention, the system further comprises a local search engine configured to render location specific search results on the user terminal.

In an embodiment of the present invention, the system further comprises a message analyzer configured to extract Internet Protocol (IP) address and device specific information of the user terminal from the request.

In an embodiment of the present invention, the system further comprises a Request Device Cache (RDC) configured to tag the IP address with the corresponding device specific information and store the tagged information.

In an embodiment of the present invention, the system further comprises a Modified Domain Name Server (MDNS) to determine whether the user terminal is capable of receiving search results from one or more predetermined websites, an Intermediate Web Server (IWS) to modify the web pages of the search results if the user terminal is not capable of rendering the search results from the one or more predetermined websites, and a Domain Database (DDB) to include information related to one or more websites from which the user terminal is capable of accessing search results.

### BRIEF DESCRIPTION OF THE DRAWINGS

The present invention is described by way of embodiments illustrated in the accompanying drawings wherein:

FIG. 1 is a block diagram illustrating components of a Wireless Local Area Network (WLAN) operating in accordance with the present invention;

FIG. 2 is a block diagram illustrating various software and hardware components of a WLAN operating in accordance with the present invention;

FIG. 3 illustrates a block diagram of a wireless environment aiding web services; and

FIG. 4 is a flowchart illustrating a method of providing value added services to a user terminal by an access point in a WLAN.

### DETAILED DESCRIPTION

A system and method for providing value added services in a wireless local area network are described herein. The invention provides an intelligent access point which can deliver information in a device friendly manner by combining location information and information queried by the user.

The following disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The present invention would now be discussed in context of embodiments as illustrated in the accompanying drawings.

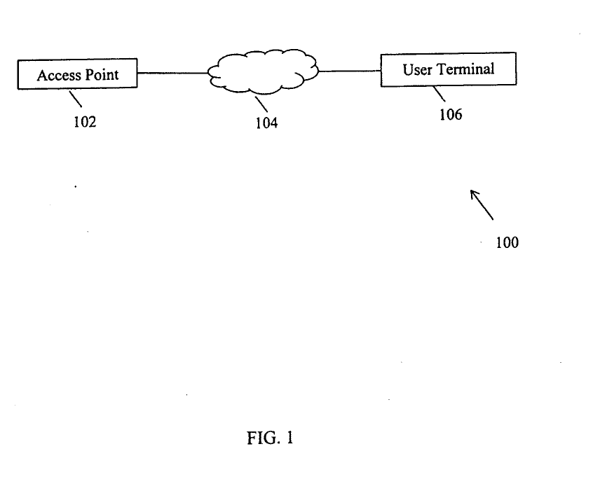

FIG. 1 is a block diagram of a Wireless Local Area Network (WLAN) operating in accordance with the present invention. The wireless network 100 comprises an access point (AP) 102, a wireless medium 104, and a user terminal 106. Examples of user terminal 106 include, but are not limited to, mobile computing device such as personal digital assistant, laptop, notebook, portable navigator, etc.

AP 102 is a network device that facilitates wireless communication devices to connect to wireless network using various wireless standards such as 802.11, Infrared (IR), Wi-Fi, Bluetooth etc. In an embodiment of the present invention, AP 102 acts as a connection point between wireless user terminals and wireless network and transmits data over the wireless medium 104. In another embodiment of the present invention, the data transmitted by the access point 102 is received by user terminal 106 when it is within transmission range of the access point 102.

User terminal 106 is a computing device capable of wireless communication. The user terminal 106 acts as a receiver and accepts data transmitted by the access point 102 over the wireless medium 104. In an example, the user terminal 106 scans each available frequency channel for a specified period of time in order to discover existing WLAN networks in its vicinity. In another example, the user terminal 106 sends probe requests for discovering the networks. The user terminal 106 receives frames from access points 102 within range, advertising their Service Set Identifiers (SSID). In various embodiments of the present invention, when a frame is received by a Network Interface Card (NIC) of the user terminal 106, the SSID field is processed. The user terminal 106 reassembles data frames obtained from the SSID field of each frame in order to obtain the data transmitted by the access point 102. An example of the user terminal 106 includes a mobile computing device used by a user to access information using a wireless connection within the premises of an airport, while waiting for his connecting flight.

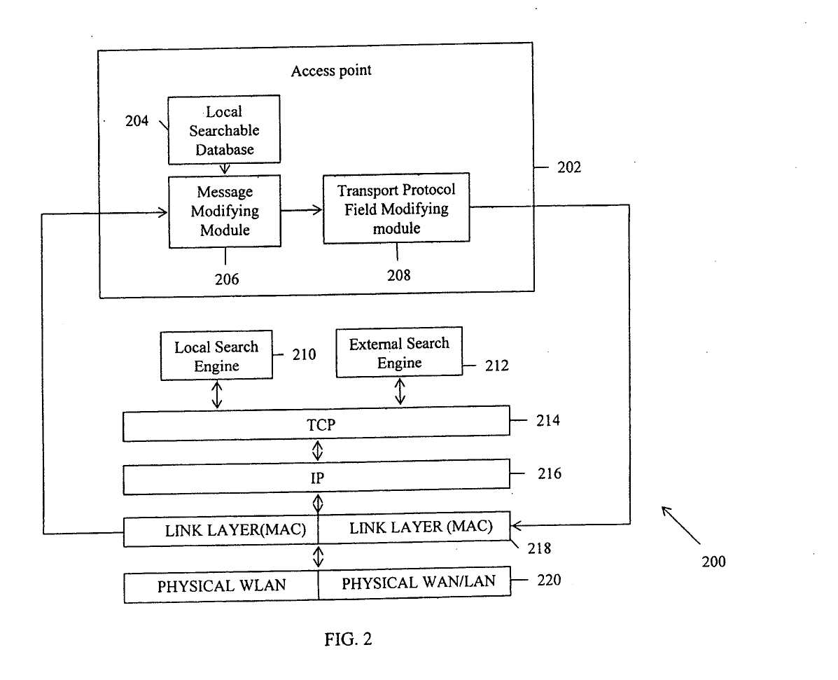

FIG. 2 is a block diagram illustrating various software and hardware components of a WLAN 200 operating in accordance with the present invention. In an embodiment of the present invention, the WLAN 200 includes an Access Point (AP) 202, a Local Search Engine (LSE) 210, an External Search Engine (ESE) 212, Transport Control Protocol (TCP) 214, Internet Protocol (IP) 216, link layer 218, and a physical layer 220.

AP 202 comprises a Local Searchable Database (LSD) 204, Message Modifying (MM) module 206, and a Transport Protocol Field Modifying (TPFM) module 208.

LSE 210 is a software module that facilitates search of information in a local repository. In an embodiment of the present invention, the local repository is a database which may include information pertaining to a user's geographical location (e.g. pertaining to movement of the user or current positioning of the user). The information may include web pages, images, and other types of files. In another embodiment of the present invention, LSE 210 may mine data available in open directories, databases, or online news and books. In an exemplary embodiment of the present invention, LSE 210 may include list of all restaurants serving Italian food in a specific geographic location such as MG Road, Chicago, where a user is located.

ESE 212 is a software module that facilitates search of information on the World Wide Web (WWW). Typical examples of ESE 212 may include, but are not limited to Google, Yahoo, MSN, AltaVista, etc. The information may include web pages, images, information and other types of files. In another embodiment of the present invention, ESE 212 may mine data available in open directories, databases, or online news and books.

TCP 214 is a primary protocol in the Internet Layer of the Internet Protocol Suite that facilitates two hosts, for example, the user terminal 106 (FIG. 1) and the access point 102 (FIG. 1) to establish a connection and exchange streams of data. In an embodiment of the present invention, TCP provides reliable, ordered delivery of a stream of bytes sent from one application on wireless device such as a user terminal 106 to another application on another wireless device such as an access point 102, and vice versa. In another embodiment of the present invention, TCP controls message size, rate at which messages are exchanged, and network traffic congestion.

IP 216 is a primary protocol in the Internet Layer of the Internet Protocol Suite that delivers datagrams and packets from a source device to a destination device based on their addresses. In an embodiment of the present invention, IP 216 defines addressing methods and structures for datagram encapsulation. In an embodiment of the present invention, Internet Protocol Version 4 (IPv4) is employed as a primary protocol. In another embodiment of the present invention, Internet Protocol Version 6 (IPv6) is employed as a primary protocol.

Link layer 218 is the second layer in the seven-layer OSI model of computer networking and is a protocol that operates on network links of hosts. A network link is a physical and logical network component used to interconnect hosts or nodes in a network. In an embodiment of the present invention, link layer 218 is a suite of methods and standards that operate between adjacent network nodes of a LAN or a WAN. In another embodiment of the present invention, link layer 218 includes a sub-layer such as a Media Access Control (MAC) layer. MAC layer provides addressing and channel access control mechanisms that facilitate user terminals/network nodes to communicate within a LAN or WAN. In yet another embodiment of the present invention, the MAC sub-layer acts as an interface between a Logical Link Control (LLC) sub-layer and the network's physical layer.

Physical layer 220 is the first and lowest layer in the seven-layer OSI model of computer networking. Physical layer 220 comprises the basic hardware transmission technologies of a network. In an embodiment of the present invention, physical layer 220 is a fundamental layer that provides an electrical, mechanical, and procedural interface to the transmission medium. Physical layer 220 components include, but are not limited to, electrical connectors, broadcast frequencies, modulation schemes and low-level parameters.

LSD 204 is employed to ascertain whether a search request is seeking local information or not. In an embodiment of the present invention, LSD 204 is a local searchable repository having all the possible keywords and rules pertaining to information related to a specific geographic location so that a quick mapping/comparison can be carried out to determine whether a user request pertains to a local area.

MM module 206 is a software module which receives Hyper Text Transfer Protocol (HTTP) requests from a user and determines whether the HTTP requests pertain to search requests. In an embodiment of the present invention, MM module 206 extracts the search keywords and compares them with the keywords in the LSD 204 to determine whether the search request is a local search request. In another embodiment of the present invention, MM module 206 inserts additional data such as location information to the HTTP request when the search request is a local search request.

TPFM module 208 is a software module which receives the search requests from MM module 206. In an embodiment of the present invention, TPFM module 208 modifies the Sequence Number Field in TCP header of the HTTP request packet based on additional data inserted by MM module 206. In another embodiment of the present invention, TCP acknowledgement packet is received from access point 106 (FIG. 1) only for the data which is received. In yet another embodiment of the present invention, no acknowledgement is provided when the additional data is inserted to the HTTP request by MM module 206.

In various embodiments of the present invention, whenever a response is received from the ESE 212 the MM module 206 appends a link to the response and pushes the packet to TPFM module 208. In another embodiment of the present invention, by clicking the link the user is able to send the same search query to the LSE 210.

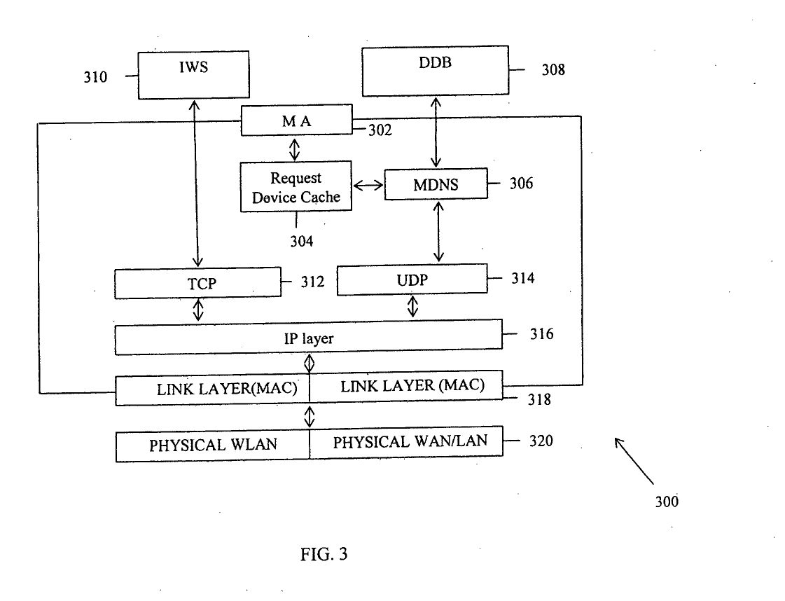

FIG. 3 illustrates a block diagram of a wireless environment aiding web services. The wireless environment 300 includes a Message Analyzer (MA) 302, Request Data Cache (RDC) 304, Modified Domain Name Server (MDNS) 306, Domain Database (DDB) 308, Intermediate Web Server (IWS) 310, TCP 312, UDP 314, IP 316, link layer 318, and a physical layer 320.

MA 302 receives a copy of all the data packets from Link Layer 214 (FIG. 2). In an embodiment of the present invention, MA 302 parses HTTP header of the data packets and extracts device specific information from a user agent field in the HTTP header. In another embodiment of the present invention, MA 302 extracts IP address of the user terminal from IP packet header of the data packets. The MA 302 uses the IP address of the user terminal to store and retrieve device specific information.

RDC 304 tags the user agent data with IP address of corresponding user terminal. In another embodiment of the present invention, RDC 304 outputs user agent data in response to an IP address of a corresponding user terminal.

MDNS 306 receives Domain Name Server (DNS) request from a user terminal and extracts IP address of the user terminal. In one embodiment of the present invention, DNS request is used to retrieve device specific information from the RDC 304. If it is a handheld device (e.g. mobile phones, PDAs etc.) then MDNS 306 uses the URL information available in the DNS query and determines whether the requested website supports handheld devices. If it doesn't then MDNS 306 returns Intermediate Web Server's (IWS) address as response to the DNS query packet.

DDB 308 is a database which comprises information pertaining to compatibility of various devices. The DDB 308 is used to ascertain whether a particular web site supports a particular user terminal and can render contents.

IWS 310 receives HTTP (web page) requests from the user terminals and fetches the web pages from the actual web site where the requested content is available. In an embodiment of the present invention, IWS 310 modifies the web pages of search results if the user terminal is not capable of rendering the search results from the one or more predetermined websites.

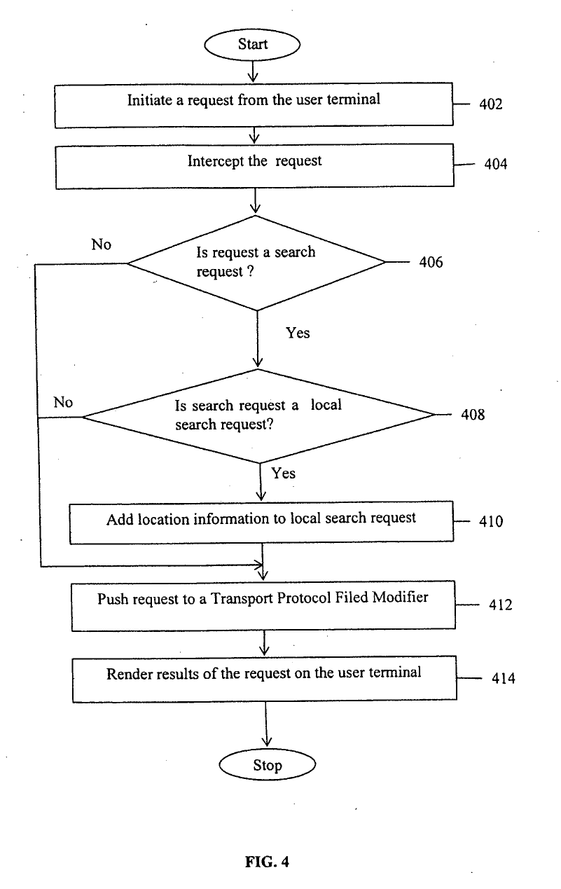

FIG. 4 is a flowchart illustrating a method of providing value added services to a user terminal by an access point in a wireless network.

At step 402, a request is initiated by a user. In an embodiment of the present invention, the request may be initiated by a user terminal for accessing information from an external search engine. In an exemplary embodiment of the present invention, the request may be a Hyper Text Transfer Protocol (HTTP) request initiated by a user for accessing a web page from World Wide Web (WWW).

At step 404, the request is intercepted. In an embodiment of the present invention, the request is intercepted at link layer protocol of Internet Protocol Suite of the wireless network. In another embodiment of the present invention, the request contents are parsed and relevant information is extracted.

At step 406, a check is performed to determine whether the request is a search request. In various embodiments of the present invention, the check is performed based on content of the request and website to which the request is directed. In an exemplary embodiment of the present invention, the user terminal may initiate a search request for accessing information from one or more search engines present in the wireless network.

If the request is a search request, then, at step 408, a check is performed to determine whether the search request is a local search request. In an embodiment of the present invention, a local search request is a request in which requested information pertains to a geographical location of the user terminal. In various embodiments of the present invention, the check is performed by comparing information present in a Local Searchable Database (LSD). In another embodiment of the present invention, LSD is a repository that comprises keywords pertaining to location information such as ATM, restaurants, shopping malls, etc.

If the search request is a local search request, then at step 410, location information pertaining to geographical location of the access point is added to the local search request. In an embodiment of the present invention, the location information comprises at least one of: user location, latitude and longitude information of access point to which a user is connected. In another embodiment of the present invention, the location information is added to the search request via HTTP extension headers. In an exemplary embodiment of the present invention, if the user initiates a request for taxi service via the access point in San Jose, the final request sent to search engine is “Taxi+San Jose”.

At step 412, the request is pushed to a Transport Protocol Field Modifying (TPFM) module. In an embodiment of the present invention, when the request is neither a search request, nor a local search request, the request is pushed to the TPFM module without any modification. In another embodiment of the present invention, when the request is a local search request, the Sequence Number Field (SNF) and checksum field in TCP header, and size and checksum field in IP header are modified by the TPFM module based on location information which is appended to the request. In yet another embodiment of the present invention, the request is pushed to the link layer protocol by the TPFM module when the request is modified. In various embodiments of the present invention, whenever an acknowledgement packet is received for the modified search request sent by the access point, the TPFM module will modify the acknowledgement number field so that the user terminal receives acknowledgement only for the data it has sent and not for the modified request sent by AP.

At step 414, the results of the request are rendered on the user terminal. In an embodiment of the present invention, when the request is a local search request, the local search request is redirected to a local search engine for rendering location specific search results on the user terminal. In another embodiment of the present invention, the search results received from an external search engine are combined with location specific search results to render the combined search results on the user terminal. In yet another embodiment of the present invention, the search results are rendered from one or more websites on the user terminal based on capabilities of the user terminal, the user terminal capabilities being at least one of: screen size and browser support. In yet another embodiment of the present invention, the web pages of the search results may be modified according to capabilities of the user terminal. In yet another embodiment of the present invention, the advertisements may be delivered when the user terminal navigates between web pages associated with the search results.

The present invention may be implemented in numerous ways including as a system, a method, or a computer readable medium such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

1. A method for providing value added services to a user terminal by an access point in a wireless network, the method comprising the steps of:
intercepting a request, the request being initiated by a user terminal for accessing information;
determining if the request comprises a search request;
determining if the search request corresponds to a local search request;
adding location information to the search request if the request is a local search request; and
rendering location specific search results on the user terminal.

2. The method of claim 1, wherein the request is determined as a search request based on at least one of: website to which the request is directed and content of the request.

3. The method of claim 1, wherein the request is determined as a local search request based on information present in a Local Searchable Database (LSD).

4. The method of claim 1, wherein the location information comprises at least one of: user location, latitude and longitude information of the access point to which the user is connected.

5. The method of claim 1 further comprising:
combining search results received from an external search engine with location specific search results; and
rendering the combined search results on the user terminal.

6. The method of claim 1 further comprising:
extracting Internet Protocol (IP) address and device specific information of the user terminal from the request;
tagging the IP address with the corresponding device specific information; and
storing the tagged information in a Request Data Cache (RDC).

7. The method of claim 6 further comprising rendering search results from one or more websites on the user terminal based on capabilities of the user terminal, the user terminal capabilities being at least one of: screen size and browser support.

8. The method of claim 7 further comprising modifying search results when one or more websites do not provide search results according to capabilities of the user terminal.

9. The method of claim 1 further comprising delivering advertisements when the user terminal navigates between web pages associated with the search results.

10. A system for providing value added services to a user terminal in a wireless network, the system comprising:
a user terminal configured to initiate a request for accessing information from one or more search engines;
an access point comprising:
a Local Searchable Database (LSD) to store keywords relating to one or more local search requests;
a Message Modifying (MM) module to intercept and add location information to the request, if the request is a local search request, thereby rendering location specific search results on the user terminal.

11. The system of claim 10 further comprising a Transport Protocol Field Modifying (TPFM) module to modify Transport Control Protocol (TCP) header of the request based on the location information.

12. The system of claim 10 further comprising an external search engine configured to receive requests from the user at TCP layer of Internet Protocol Suite of the wireless network.

13. The system of claim 12 further comprising a local search engine configured to render location specific search results on the user terminal.

14. The system of claim 13 further comprising a message analyzer configured to extract Internet Protocol (IP) address and device specific information of the user terminal from the request.

15. The system of claim 10 further comprising a Request Device Cache (RDC) configured to:
tag the IP address with the corresponding device specific information; and
store the tagged information.

16. The system of claim 12 further comprising:
a Modified Domain Name Server (MDNS) to determine whether the user terminal is capable of receiving search results from one or more predetermined websites;
an Intermediate Web Server (IWS) to modify the web pages of the search results if the user terminal is not capable of rendering the search results from the one or more predetermined websites; and
a Domain Database (DDB) to include information related to one or more websites from which the user terminal is capable of accessing search results.

17. A computer program product comprising a computer usable medium having a computer readable program code embodied therein for providing value added services to a user terminal by an access point in a wireless network, the computer program product comprising:
program instruction means for intercepting a request, the request being initiated by a user terminal for accessing information;
program instruction means for determining if the request comprises a search request;
program instruction means for determining if the search request corresponds to a local search request;
program instruction means for adding location information to the search request if the request is a local search request; and
program instruction means for rendering location specific search results on the user terminal.

18. The computer program product of claim 17, wherein the request is determined as a search request based on at least one of: website to which the request is directed and content of the request.

19. The computer program product of claim 17, wherein the request is determined as a local search request based on information present in a Local Searchable Database (LSD).

20. The computer program product of claim 17, wherein the location information comprises at least one of: user location, latitude and longitude information of the access point to which the user is connected.

21. The computer program product of claim 17 further comprising:
program instruction means for combining search results received from an external search engine with the location specific search results; and
program instruction means for rendering the combined search results on the user terminal.

22. The computer program product of claim 17 further comprising:
program instruction means for extracting Internet Protocol (IP) address and device specific information of the user terminal from the request;
program instruction means for tagging the IP address with the corresponding device specific information; and
program instruction means for storing the tagged information in a Request Data Cache (RDC).

23. The computer program product of claim 22 further comprising program instruction means for rendering search results from one or more websites on the user terminal based on capabilities of the user terminal, the user terminal capabilities being at least one of: screen size and browser support.

24. The computer program product of claim 23 further comprising program instruction means for modifying search results when one or more websites do not provide search results according to capabilities of the user terminal.

25. The computer program product of claim 17 further comprising program instruction means for delivering advertisements when the user terminal navigates between web pages associated with the search results.
